(19) United States
(12) Patent Application Publication
(10) Pub. No.: US 2025/0196713 A1
(43) Pub. Date: Jun. 19, 2025

(54) ELECTRIFIED VEHICLE

(71) Applicant: TOYOTA JIDOSHA KABUSHIKI KAISHA, Toyota-shi (JP)

(72) Inventors: Yu WATANABE, Nagakute-shi (JP); Toru ANDO, Obu-shi (JP)

(73) Assignee: TOYOTA JIDOSHA KABUSHIKI KAISHA, Toyota-shi (JP)

(21) Appl. No.: 18/931,489

(22) Filed: Oct. 30, 2024

(30) Foreign Application Priority Data
Dec. 18, 2023 (JP) 2023-213067

(51) Int. Cl. B60L 58/14; B60L 53/20; B60R 16/033

(52) U.S. Cl. CPC B60L 58/14; B60L 53/20; B60R 16/033; B60L 2210/10; B60L 2210/30

(57) ABSTRACT

An electrified vehicle includes a battery, an inlet to which a power supply connector of an external charging equipment is connected, a predetermined in-vehicle device that uses an auxiliary battery as a power source and is used for charging the battery, and a control device that activates the predetermined in-vehicle device in response to an activation request periodically transmitted from the external charging equipment while the power supply connector is connected to the inlet, and stops the predetermined in-vehicle device in response to a transmission stop of the activation request, and the control device prohibits the activation of the predetermined in-vehicle device in response to the activation request when the physical quantity representing the power consumption of the predetermined in-vehicle device becomes equal to or more than a predetermined threshold while the charging of the battery is stopped and the power supply connector is connected to the inlet.

### CROSS-REFERENCE TO RELATED APPLICATION

This application claims priority to Japanese Patent Application No. 2023-213067 filed on Dec. 18, 2023, incorporated herein by reference in its entirety.

### BACKGROUND

### 1. Technical Field

The present disclosure relates to an electrified vehicle capable of charging a battery with electric power from external charging equipment.

### 2. Description of Related Art

Hitherto, there is known a vehicle including a battery and a control device including an arithmetic unit and a storage unit and capable of charging the battery with electric power from a charging station (see, for example, Japanese Unexamined Patent Application Publication No. 2020-120445 (JP 2020-120445 A)). In this vehicle, when a charging abnormality is detected by the arithmetic unit after the end of the charging of the battery at the charging station etc. that does not conform to standards, abnormality information and countermeasure control related to the charging abnormality are stored in the storage unit in association with station information of the charging station. In the subsequent charging of the battery at the same or different charging station, the control device requests the charging station to perform the countermeasure control stored in the storage unit or countermeasure control set based on the abnormality information.

### SUMMARY

When a battery of a vehicle is charged with electric power from external charging equipment, various signals are transmitted from the external charging equipment to the vehicle during a period from the time when a power supply connector of the external charging equipment is connected to an inlet of the vehicle to the time when the power supply connector is detached. In the vehicle described above, when a request that is not determined to be abnormal on the vehicle side is transmitted from the external charging equipment, a process corresponding to the request is performed on the vehicle side. Depending on the content of the request from the external charging equipment, however, the process corresponding to the request on the vehicle side may cause a trouble on the vehicle side.

In view of this, the present disclosure has a main object to satisfactorily suppress a trouble in an electrified vehicle due to a request from external charging equipment while a power supply connector of the external charging equipment is connected to an inlet of the electrified vehicle.

An electrified vehicle of the present disclosure includes a battery and an inlet to which a power supply connector of external charging equipment is to be connected, and is configured to charge the battery with electric power supplied from the external charging equipment to the inlet via the power supply connector. The electrified vehicle includes:
a predetermined in-vehicle device that uses an auxiliary battery as a power supply and is used for charging the battery; and
a control device configured to activate the predetermined in-vehicle device in response to an activation request periodically transmitted from the external charging equipment while the power supply connector is connected to the inlet, and stop the predetermined in-vehicle device in response to a stop of transmission of the activation request. The control device is configured to prohibit activation of the predetermined in-vehicle device in response to the activation request when a physical quantity representing a power consumption of the predetermined in-vehicle device is equal to or more than a predetermined threshold value while charging of the battery is stopped and the power supply connector is connected to the inlet.

The electrified vehicle of the present disclosure is configured to charge the battery with electric power supplied from the external charging equipment to the inlet via the power supply connector. The electrified vehicle of the present disclosure includes the predetermined in-vehicle device that uses the auxiliary battery as the power supply and is used for charging the battery, and the control device. The control device is configured to activate the predetermined in-vehicle device in response to the activation request periodically transmitted from the external charging equipment while the power supply connector is connected to the inlet, and stop the predetermined in-vehicle device in response to a stop of transmission of the activation request. When the in-vehicle device is activated in response to the activation request from the external charging equipment, electric power from the auxiliary battery is supplied to the predetermined in-vehicle device until the transmission of the activation request is stopped by the external charging equipment. Therefore, when the activation request is repeatedly transmitted from the external charging equipment while the charging of the battery is stopped and the power supply connector is connected to the inlet, the remaining charge of the auxiliary battery decreases. In some cases, the auxiliary battery may be in an over-discharge state (battery depletion state). In view of this, the control device of the vehicle of the present disclosure is configured to prohibit activation of the predetermined in-vehicle device in response to the activation request from the external charging equipment when the physical quantity is equal to or more than the predetermined threshold value while the charging of the battery is stopped and the power supply connector of the external charging equipment is connected to the inlet. The physical quantity represents the power consumption of the predetermined in-vehicle device. Therefore, even if the activation request is repeatedly transmitted from the external charging equipment while the charging of the battery is stopped and the power supply connector is connected to the inlet, the decrease in the remaining charge of the auxiliary battery can be suppressed so that the auxiliary battery does not come into the over-discharge state. The over-discharge state is a battery depletion state. With the electrified vehicle of the present disclosure, it is possible to satisfactorily suppress a trouble due to the request from the external charging equipment while the power supply connector of the external charging equipment is connected to the inlet of the electrified vehicle.

The physical quantity may be a count of activation of the predetermined in-vehicle device while the charging of the battery is stopped and the power supply connector is connected to the inlet.

The physical quantity may be an operation period of the predetermined in-vehicle device while the charging of the battery is stopped and the power supply connector is connected to the inlet.

The physical quantity may be an amount of discharged power of the auxiliary battery while the charging of the battery is stopped and the power supply connector is connected to the inlet.

The control device may be configured to, when the power supply connector is detached from the inlet, terminate prohibition of activation of the predetermined in-vehicle device in response to the activation request and reset the physical quantity to zero.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an electrified vehicle of the present disclosure;

FIG. 2 is a flow chart illustrating a routine executed by a control device of the disclosed electrified vehicle;

FIG. 3 is a time chart illustrating the state of the vehicle and the external charging equipment when the routine of FIG. 2 is executed;

FIG. 4 is a flow chart illustrating another routine that may be performed by the control device of the disclosed electrified vehicle; and

FIG. 5 is a flow chart illustrating yet another routine that may be performed by a control device of the disclosed electrified vehicle.

### DETAILED DESCRIPTION OF EMBODIMENTS

Embodiments of the present disclosure will now be described with reference to the drawings.

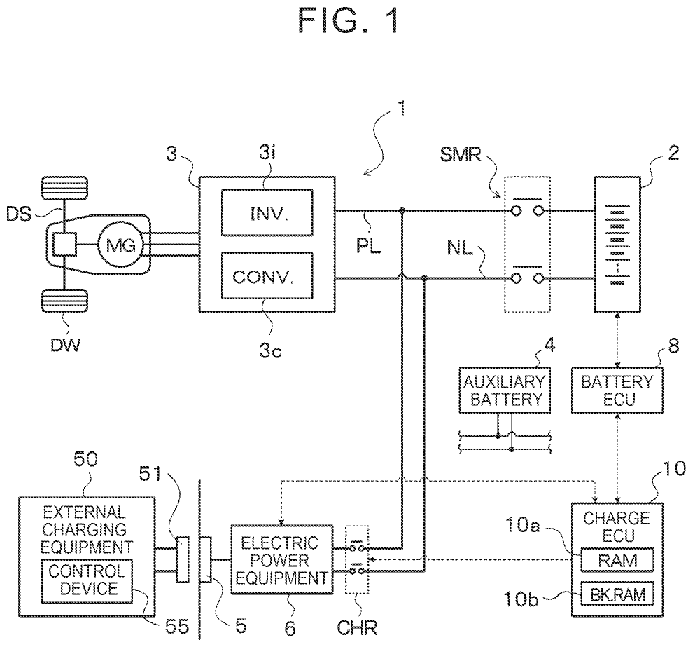

FIG. 1 is a schematic configuration diagram illustrating an electrified vehicle 1 of the present disclosure. Electrified vehicle 1 shown in the drawing is a battery electric vehicle (BEV) including a battery (power storage device) 2, a normally-open system main relay SMR, a power control device (hereinafter referred to as “PCU”) 3, an auxiliary battery 4 including a lower voltage than the battery 2, and a motor generator MG. However, electrified vehicle 1 may be a plug-in hybrid electric vehicle (PHEV) including an internal combustion engine in addition to the battery 2, the motor generator MG, and the like.

The battery 2 is, for example, a lithium-ion secondary battery or a nickel-hydrogen secondary battery including a rated output-voltage of 200 to 800 V. The positive electrode side power line PL is connected to the positive electrode terminal of the battery 2 via the positive electrode side relay of the system main relay SMR. The negative electrode side power line NL is connected to the negative electrode terminal of the battery 2 via the negative electrode side relay of the system main relay SMR.

PCU 3 includes an inverter (drive circuit) 3i for driving the motor generator MG, a step-up converter 3c, and the like, and is connected to the battery 2 via the positive electrode side power line PL, the negative electrode side power line NL, and the system main relay SMR. The auxiliary battery 4 is, for example, a lead-acid battery including a rated output-voltage of about 12 V. The auxiliary battery 4 supplies electric power (including excitation electric power) to auxiliary devices such as an electronic control unit, relays, and sensors, which are electrified vehicle 1 in-vehicle devices.

The motor generator MG is a synchronous generator motor (three-phase AC motor). The rotor of the motor generator MG is coupled to a drive shaft DS that is coupled to the drive wheel DW via a power transmission including a reduction gear and a differential gear. The motor generator MG is driven by electric power from PCU 3 (battery 2) and outputs a driving torque (driving force) to the drive shaft DS. The motor generator MG outputs regenerative braking torque to the drive shaft DS when electrified vehicle 1 is braked.

Electrified vehicle 1 further includes a charging inlet 5 and a power device 6, as shown in FIG. 1. The charging inlet 5 is disposed inside a charging lid (not shown) provided in a vehicle body of electrified vehicle 1, and is connected to the power device 6. The charging inlet 5 includes an AC receptacle (not shown) to which the power supply connector 51 of the external charging equipment 50 is connected (inserted). The external charging equipment 50 is, for example, a charging station including an AC charger, a control device 55, and the like to which the power supply connector 51 is connected via a charging cable.

The power device 6 includes a AC/DC converter and a DC/DC converter, and is connected to the positive electrode side power line PL and the negative electrode side power line NL between the system main relay SMR and PCU 3 via a charging relay CHR. When the charging relay CHR and the system main relay SMR are closed, the AC receptacle of the charging inlet 5 is connected to the battery 2 via the power device 6 or the like. Thus, when the power supply connector 51 of the external charging equipment 50 is connected to the charging inlet 5, the battery 2 can be charged by electric power supplied from the outside of the vehicle via the power supply connector 51 or the like.

Further, electrified vehicle 1 includes a battery electronic control unit (hereinafter, referred to as a “battery ECU”) 8 that manages the battery 2 and a charging electronic control unit (hereinafter, referred to as a “charging ECU”) 10. The battery ECU 8 includes a microcomputer including a CPU, a ROM, RAM, a storage device, and the like (not shown). The battery ECU 8 acquires the inter-terminal voltage, the charge-discharge current, the temperature, and the like of the battery 2 from the corresponding sensor, and calculates SOC, the allowable charge power Win, the allowable discharge power Wout, and the like of the battery 2 based on these physical quantities. The charging ECU 10 includes a microcomputer including a CPU, a ROM, RAM 10a, a back-up RAM 10b, a storage device, and the like. RAM 10a of the charging ECU 10 is a volatile memory, and the back-up RAM 10b is powered by the auxiliary battery 4 so as to continue holding the data when electrified vehicle 1 is in sleep.

The charging ECU 10 interacts with the battery ECU 8 to control the power device 6 and to open and close the charging relay CHR. Further, in the charging ECU 10, when the power supply connector 51 of the external charging equipment 50 is connected to the charging inlet 5 (AC receptacle) of electrified vehicle 1, it is connected to the control device 55 of the external charging equipment 50 via a communication line (not shown). The control device 55 includes a microcomputer or the like including a CPU, a ROM, RAM, a storage device, or the like (not shown). The control device 55 exchanges various types of data with the charging ECU 10, such as an activation request for electrified vehicle 1, to control the electric power equipment and the like of the external charging equipment 50.

In the present embodiment, the charging ECU 10 is activated in response to an activation request (pulsed signal) from the external charging equipment 50 after the power supply connector 51 is connected to the charging inlet 5. Further, the charging ECU 10 sets the activation prohibition flag Fp stored in the backup RAM 10b to “0” in order to permit activation of a predetermined in-vehicle device to be used for charging the battery 2 in response to the activation request. Then, the charging ECU 10 starts supplying power from the auxiliary battery 4 to the predetermined in-vehicle device. In the present embodiment, the predetermined in-vehicle device includes a corresponding sensor connected to a charging ECU 10, a system main relay SMR, a charging relay CHR, a battery ECU 8, a corresponding sensor connected to the battery ECU 8, and the like. Further, when the transmission (pulse signal) of the activation request from the external charging equipment 50 to the charging ECU 10 is stopped, the charging ECU 10 stops the power supply from the auxiliary battery 4 to a predetermined in-vehicle device such as a battery ECU 8 activated in response to the activation request. When the predetermined in-vehicle device is stopped, electrified vehicle 1 including the charging ECU 10 transitions to the sleep mode.

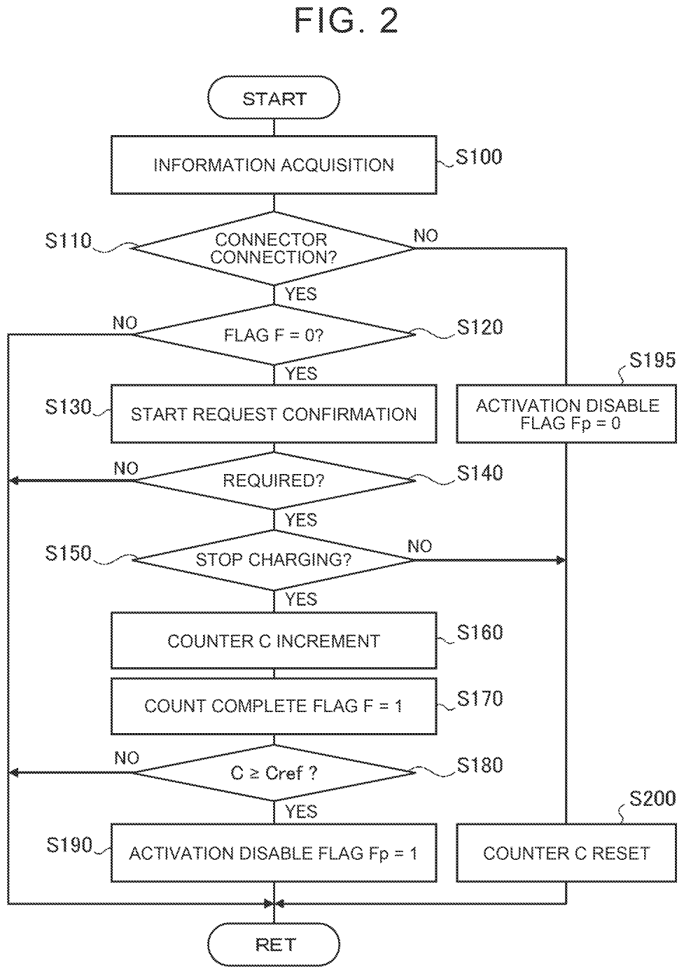

FIG. 2 is a flow chart showing a routine that is repeatedly executed every predetermined time (minute time) by the charging ECU 10 while the power supply connector 51 of the external charging equipment 50 is connected to the charging inlet 5 (AC receptacle) of electrified vehicle 1.

When the timing of executing the routine of FIG. 2 arrives, the charging ECU 10 acquires information such as the value of the connector connecting flag, the value of the count completion flag F, and the value of the charging flag (S100). The connector connection flag is set to “0” when the power supply connector 51 of the external charging equipment 50 is not connected to the charging inlet 5. Further, the connector connection flag is set to “1” when the power supply connector 51 of the external charging equipment 50 is connected to the charging inlet 5. The count completion flag F is set to “1” when a predetermined process is executed. The charging flag is set to “0” when the charging of the battery 2 is stopped, and is set to “1” when the battery 2 is charged. In the present embodiment, the value of the connector connection flag and the value of the charge flag are stored in the backup RAM 10b described above. The count completion flag F is stored in RAM 10a and is reset to “0” when electrified vehicle 1 (charging ECU 10) transitions to the sleep mode.

Next, the charging ECU 10 determines whether or not the power supply connector 51 is connected to the charging inlet 5 based on the connector connection flag acquired by S100 (S110). When the power supply connector 51 is connected to the charging inlet 5 (S110: YES), the charging ECU 10 determines whether or not the count completion flag F acquired by S100 is “0” (S120). When the value of the count completion flag F is “0” (S120: YES), the charging ECU 10 checks whether or not an activation request (pulsed signal) is transmitted from the external charging equipment 50 (control device 55) including the power supply connector 51 (S130).

When the activation request is not transmitted from the external charging equipment 50 (S140: NO), the charging ECU 10 skips the subsequent process and terminates the routine of FIG. 2 once. When the activation request is transmitted from the external charging equipment 50 (S140: YES), the charging ECU 10 determines whether or not the charging of the battery 2 is stopped based on the charging flag acquired by S100 (S150). When the value of the charging flag is “1” and the charging of the battery 2 is performed (S150: NO), the charging ECU 10 resets the value of the predetermined counter C stored in the backup RAM 10b to zero (S200), and ends the routine of FIG. 2 once.

When the charge flag is “0” and the charge of the battery 2 is stopped (S150: YES), the charging ECU 10 increments the counter C stored in the back-up RAM 10b (S160). Further, the charging ECU 10 sets the count completion flag F stored in RAM 10a to “1” (S170). Subsequently, the charging ECU 10 determines whether or not the counter C is equal to or greater than a predetermined threshold Cref (S180). If the counter C is less than the threshold Cref (S180: NO), the charging ECU 10 terminates the routine of FIG. 2 once at that point. The charging ECU 10 separately activates a predetermined in-vehicle device such as a battery ECU 8 in response to an activation request from the external charging equipment 50. Power from the auxiliary battery 4 is continuously supplied to the predetermined in-vehicle device activated in response to the activation request until transmission of the activation request (pulse signal) is stopped by the external charging equipment 50.

Also, after the count completion flag F is set to “1” in S170, if the processing after S100 is executed, a negative determination is made in S120, and the subsequent processing is skipped. That is, after the count completion flag F is once set to “1” in S170, the counter C is not incremented until the count completion flag F is reset in response to the transition to the sleep mode. Therefore, the counter C corresponds to the number of times of activation of the predetermined in-vehicle device (and the number of times of activation request from the external charging equipment 50) while the charging of the battery 2 is stopped and the power supply connector 51 is connected to the charging inlet 5.

On the other hand, when the counter C is equal to or larger than the threshold Cref (S180: YES), the charging ECU 10 sets the activation prohibition flag Fp stored in the backup RAM 10b to “1” (S190) in order to prohibit the activation of the predetermined in-vehicle device in response to the activation request from the external charging equipment 50, and ends the routine of FIG. 2 once. When the activation prohibition flag Fp is once set to “1” in S190, the charging ECU 10 maintains the activation prohibition flag Fp at “1” even if an activation request is subsequently transmitted from the external charging equipment 50. Therefore, when the activation prohibition flag Fp is set to “1” in S190, even if an activation request is transmitted from the external charging equipment 50 thereafter, a predetermined in-vehicle device such as a battery ECU 8 is not activated, and electrified vehicle 1 is maintained in the sleep state.

In addition, it may be determined that the power supply connector 51 is not connected to the charging inlet 5 based on the connector connection flag acquired by S100 (S110: NO). In this case, the charging ECU 10 sets the activation prohibition flag Fp stored in the backup RAM 10b to “0” in order to permit the activation of the predetermined in-vehicle device in response to the activation request from the external charging equipment 50 (S195). Further, the charging ECU 10 resets the counter C to zero (S200) and terminates the routine of FIG. 2 once.

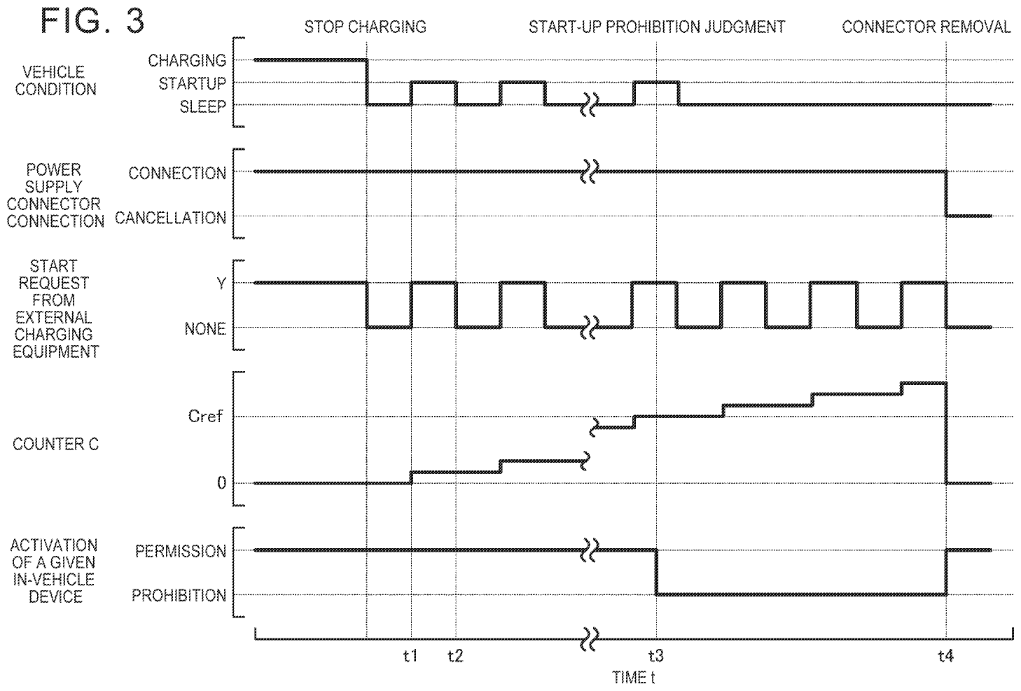

As a consequence of executing the routine of FIG. 2 as described above, in electrified vehicle 1, while the power supply connector 51 of the external charging equipment 50 is connected to the charging inlet 5 and the charging of the battery 2 is stopped, as shown in FIG. 3, a predetermined in-vehicle device such as a battery ECU 8 is activated in response to an activation request from the external charging equipment 50 (control device 55) (see the time t1 in FIG. 3). In addition, the charging ECU 10 stops a predetermined in-vehicle device such as a battery ECU 8 (see time t2 in FIG. 3) and shifts electrified vehicle 1 to the sleep state in response to the stop of transmitting the start-up request by the external charging equipment 50.

Here, the control device 55 of the external charging equipment 50 includes a device that periodically and repeatedly transmits an activation request to electrified vehicle 1 while the charging of the battery 2 is completed (charging is stopped) and the power supply connector 51 is connected to the charging inlet 5 of electrified vehicle 1. For example, one of the control devices 55 outputs a pulse signal as an activation request continuously for a predetermined time, and then stops the output of the pulse signal for, for example, a few seconds to 30 seconds, and outputs the pulse signal continuously for a predetermined time again. Further, when a predetermined in-vehicle device is activated in response to an activation request from the external charging equipment 50, power from the auxiliary battery 4 is supplied to the predetermined in-vehicle device until transmission of the activation request is stopped by the external charging equipment 50. In some cases, a start request is repeatedly transmitted from the external charging equipment 50 while the charging of the battery 2 is stopped while the power supply connector 51 is connected to the charging inlet 5, in this case, the remaining capacity of the auxiliary battery 4 decreases, and in some cases, there is a possibility that the auxiliary battery 4 becomes an overdischarge state (battery rise state).

In view of this, in electrified vehicle 1, when the charging of the battery 2 is stopped and the counter C corresponding to the number of times of activation of the predetermined in-vehicle device becomes equal to or larger than a predetermined threshold Cref while the power supply connector 51 of the external charging equipment 50 is connected to the charging inlet 5 (S180: YES, see time t3 in FIG. 3), the activation of the predetermined in-vehicle device corresponding to the activation demand from the external charging equipment 50 is prohibited by the charging ECU 10 (S190). Thus, even if the activation request is repeatedly transmitted from the external charging equipment 50 while the charging of the battery 2 is stopped while the power supply connector 51 is connected to the charging inlet 5, it is possible to suppress a decrease in the remaining capacity of the auxiliary battery 4 so that the auxiliary battery 4 does not go into an overdischarge state (battery rise state). Consequently, in electrified vehicle 1, while the power supply connector 51 of the external charging equipment 50 is connected to the charging inlet 5 of electrified vehicle 1, it is possible to satisfactorily suppress the occurrence of a defect due to a start-up demand from the external charging equipment 50.

The counter C corresponds to the number of times of activation of a predetermined in-vehicle device (such as a battery ECU 8) while the charging of the battery 2 is stopped and the power supply connector 51 is connected to the charging inlet 5. The counter C represents the amount of power consumed by the predetermined in-vehicle device while the charging of the battery 2 is stopped and the power supply connector 51 is connected to the charging inlet 5. That is, the amount of electric power consumed by a predetermined in-vehicle device such as a battery ECU 8 after being started up in response to an activation request from the external charging equipment 50 until being stopped can be estimated in advance. Therefore, by incrementing the counter C and counting the number of times of activation of a predetermined in-vehicle device, charging of the battery 2 can be stopped. At the same time, it is possible to appropriately grasp the amount of power consumed by a predetermined device while the power supply connector 51 is connected to the charging inlet 5. Consequently, when the counter C becomes equal to or larger than the predetermined threshold Cref and the activation of the predetermined in-vehicle device in response to the activation request from the external charging equipment 50 is prohibited (S180: YES, S190), it is possible to suppress the decrease in the remaining capacity of the auxiliary battery 4 extremely satisfactorily.

Further, when the power supply connector 51 is removed from the charging inlet 5 (see S110: NO, time t4 in FIG. 3), the charging ECU 10 cancels prohibition of activation of a predetermined in-vehicle device in response to the activation request (S195). At the same time, the charging ECU 10 resets the counter C, which is a physical quantity corresponding to the amount of power consumed by the predetermined in-vehicle device, to zero (S200). Thus, when the power supply connector 51 is connected to the charging inlet 5 again, it is possible to smoothly start charging of the battery 2 by electric power from the external charging equipment 50.

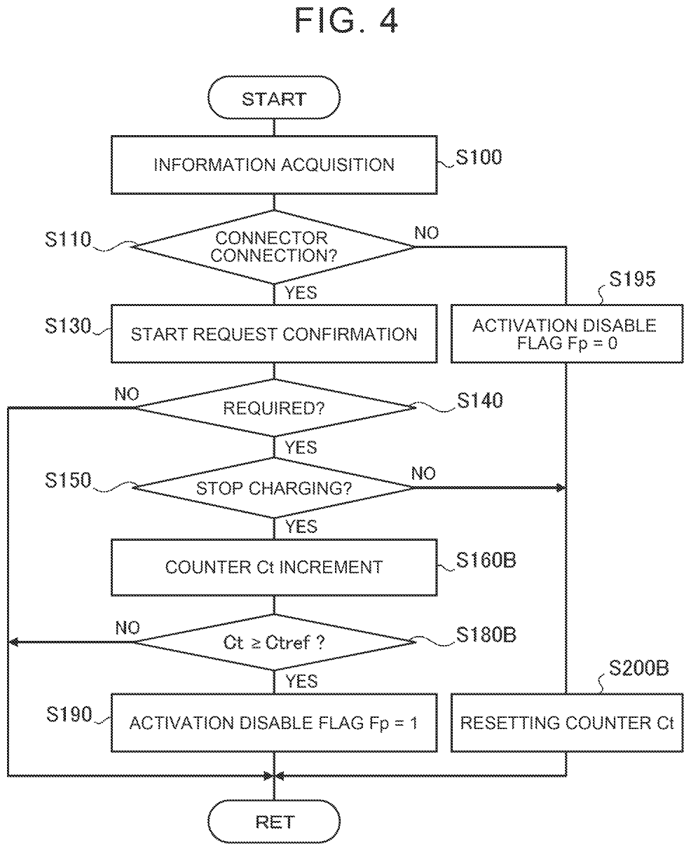

FIG. 4 is a flow chart showing another routine that can be repeatedly executed at predetermined time intervals (minute time intervals) by the charging ECU 10 while the power supply connector 51 of the external charging equipment 50 is connected to the charging inlet 5 (AC receptacle) of electrified vehicle 1.

When the routine of FIG. 4 arrives, the charging ECU 10 acquires required information such as the value of the connector connecting flag and the value of the charging flag (S100), and determines whether or not the power supply connector 51 is connected to the charging inlet 5 (S110). When the power supply connector 51 is connected to the charging inlet 5 (S110: YES), the charging ECU 10 checks whether or not an activation request is transmitted from the external charging equipment 50 (the control device 55) including the power supply connector 51 (S130).

When the activation request is not transmitted from the external charging equipment 50 (S140: NO), the charging ECU 10 skips the subsequent process and terminates the routine of FIG. 4 once. In addition, when the activation request is transmitted from the external charging equipment 50 (S140: YES), the charging ECU 10 determines whether or not the charging of the battery 2 is stopped (S150). When the battery 2 is being charged (S150: NO), the charging ECU 10 resets the predetermined counter Ct stored in the backup RAM 10b to zero (S200B), and ends the routine of FIG. 4 once.

When the charging of the battery 2 is stopped (S150: YES), the charging ECU 10 increments (S160B) the counter Ct stored in the backup RAM 10b. Further, the charging ECU 10 determines whether or not the counter Ct is equal to or greater than a predetermined threshold Ctref (S180B). If the counter Ct is less than the threshold Ctref (S180B: NO), the charging ECU 10 terminates the routine of FIG. 4 once at that point. The charging ECU 10 separately activates a predetermined in-vehicle device such as a battery ECU 8 in response to an activation request from the external charging equipment 50. The counter Ct is incremented each time the routine of FIG. 4 is executed while the power supply connector 51 is connected to the charging inlet 5 (AC receptacle) of electrified vehicle 1 and the activation request is transmitted from the external charging equipment 50. Accordingly, the counter C corresponds to the operation period of the predetermined in-vehicle device, i.e., the time during which electric power is supplied from the auxiliary battery 4 while the charging of the battery 2 is stopped and the power supply connector 51 is connected to the charging inlet 5.

On the other hand, when the counter C is equal to or larger than the threshold Ctref (S180B: YES), the charging ECU 10 sets the activation prohibition flag Fp stored in the backup RAM 10b to “1” (S190) in order to prohibit the activation of the predetermined in-vehicle device in response to the activation request from the external charging equipment 50, and ends the routine of FIG. 4 once. When the activation prohibition flag Fp is set to “1” in S190, even if the activation request is transmitted from the external charging equipment 50 thereafter, a predetermined in-vehicle device such as a battery ECU 8 is not activated, and electrified vehicle 1 is maintained in the sleep mode. Further, when it is determined that the power supply connector 51 is not connected to the charging inlet 5 (S110: NO), the charging ECU 10 sets the activation prohibition flag Fp to “0” in order to permit the activation of the predetermined in-vehicle device in response to the activation request from the external charging equipment 50 (S195). Further, the charging ECU 10 resets the counter Ct to zero (S200B) and terminates the routine of FIG. 4 once.

Even if the routine of FIG. 4 as described above is executed in electrified vehicle 1. As in the case where the routine of FIG. 2 is executed, while the power supply connector 51 of the external charging equipment 50 is connected to the charging inlet 5, it is possible to satisfactorily suppress the occurrence of a defect in electrified vehicle 1 due to the activation demand from the external charging equipment 50. The counter Ct corresponds to an operation period of a predetermined in-vehicle device (such as a battery ECU 8) while the charging of the battery 2 is stopped and the power supply connector 51 is connected to the charging inlet 5. Therefore, by incrementing the counter C and counting the operation period of the predetermined in-vehicle device, it is possible to properly grasp the amount of power consumed by the predetermined device while the charging of the battery 2 is stopped and the power supply connector 51 is connected to the charging inlet 5. Accordingly, if the activation of the predetermined in-vehicle device in response to the activation request from the external charging equipment 50 is prohibited when the counter Ct becomes equal to or larger than the predetermined threshold Ctref (S180: YES, S190), it is possible to extremely satisfactorily suppress a decrease in the remaining capacity of the auxiliary battery 4.

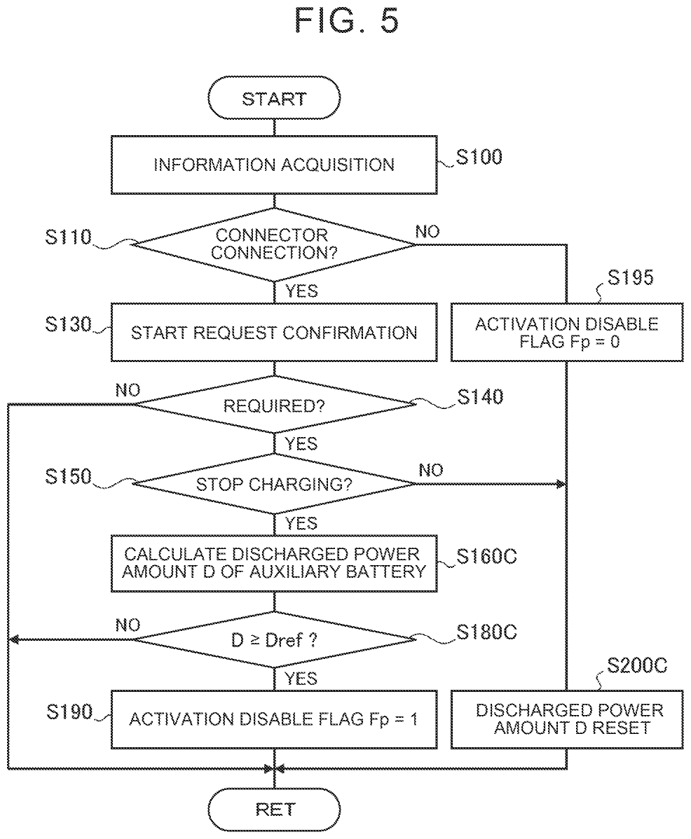

FIG. 5 is a flow chart showing still another routine that may be repeatedly executed at predetermined time intervals (minute time intervals) by the charging ECU 10 while the power supply connector 51 of the external charging equipment 50 is connected to the charging inlet 5 (AC receptacle) of electrified vehicle 1.

When the execution timing of the routine of FIG. 5 arrives, the charging ECU 10 executes the processing of S100 to S130, and when the activation request is not transmitted from the external charging equipment 50 (S140: NO), the subsequent processing is skipped and the routine of FIG. 5 is temporarily terminated. In addition, when the activation request is transmitted from the external charging equipment 50 (S140: YES), the charging ECU 10 determines whether or not the charging of the battery 2 is stopped (S150). When the charging of the battery 2 is performed (S150: NO), the charging ECU 10 resets the discharged power amount D of the auxiliary battery 4 stored in the backup RAM 10b to zero (S200C), and ends the routine of FIG. 5 once.

When the charging of the battery 2 is stopped (S150: YES), the charging ECU 10 calculates the discharged power amount D of the auxiliary battery 4 and stores the calculated discharged power amount D in the back-up RAM 10b (S160C). In S160C, the charging ECU 10 calculates a discharged power amount D by integrating a product value (discharge power) of a discharge current of the auxiliary battery 4 detected by a current sensor (not shown) and a voltage of the auxiliary battery 4 detected by a voltage sensor (not shown). Further, the charging ECU 10 determines whether or not the discharged power amount D is equal to or greater than a predetermined threshold Dref (S180C). When the discharged power amount D is less than the threshold Dref (S180C: NO), the charging ECU 10 terminates the routine of FIG. 5 at that point in time. The charging ECU 10 separately activates a predetermined in-vehicle device such as a battery ECU 8 in response to an activation request from the external charging equipment 50.

On the other hand, when the discharged power amount D is equal to or larger than the threshold Dref (S180C: YES), the charging ECU 10 sets the activation prohibition flag Fp to “1” (S190) in order to prohibit the activation of the predetermined in-vehicle device in response to the activation request from the external charging equipment 50, and ends the routine of FIG. 5 once. When the activation prohibition flag Fp is set to “1” in S190, a predetermined in-vehicle device such as a battery ECU 8 is not activated even if an activation request is transmitted from the external charging equipment 50 thereafter. Electrified vehicle 1 is maintained in sleep. Further, when it is determined that the power supply connector 51 is not connected to the charging inlet 5 (S110: NO), the charging ECU 10 sets the activation prohibition flag Fp to “0” in order to permit the activation of the predetermined in-vehicle device in response to the activation request from the external charging equipment 50 (S195). Further, the charging ECU 10 resets the discharged power amount D to zero (S200C), and terminates the routine of FIG. 5.

Even if the routine of FIG. 5 as described above is executed in electrified vehicle 1. As in the case where the routine of FIG. 2 or FIG. 4 is executed, while the power supply connector 51 of the external charging equipment 50 is connected to the charging inlet 5, it is possible to satisfactorily suppress the occurrence of a defect in electrified vehicle 1 due to the activation demand from the external charging equipment 50. That is, by comparing the discharged power amount D of the auxiliary battery 4 with the threshold Dref while the charging of the battery 2 is stopped and the power supply connector 51 is connected to the charging inlet 5, it is possible to suppress the decrease in the remaining capacity of the auxiliary battery 4 extremely satisfactorily.

The external charging equipment 50 includes an AC charger, but is not limited thereto, and may be, for example, a quick charging station including a DC charger to which a power supply connector is connected via a charging cable. The charging inlet 5 of electrified vehicle 1 may include a DC receptacle (not shown) connected to the positive electrode side power line PL and the negative electrode side power line NL via relays. The charging inlet 5 of electrified vehicle 1 may be connected (inserted) with a power supply connector of a DC-type external charging equipment to the DC receptacle.

In addition, the disclosure of the present disclosure is not limited to the above-described embodiments, and it is needless to say that various modifications can be made within the scope of the extension of the present disclosure. Furthermore, the above-described embodiment is only a specific form of the disclosure described in the column of the outline of the disclosure, and does not limit the elements of the disclosure described in the column of the outline of the disclosure.

The present disclosure is applicable to the manufacturing industry of electrified vehicle and the like.

What is claimed is:

1. An electrified vehicle including a battery and an inlet to which a power supply connector of external charging equipment is to be connected, and configured to charge the battery with electric power supplied from the external charging equipment to the inlet via the power supply connector, the electrified vehicle comprising:
a predetermined in-vehicle device that uses an auxiliary battery as a power supply and is used for charging the battery; and
a control device configured to activate the predetermined in-vehicle device in response to an activation request periodically transmitted from the external charging equipment while the power supply connector is connected to the inlet, and stop the predetermined in-vehicle device in response to a stop of transmission of the activation request, the control device being configured to prohibit activation of the predetermined in-vehicle device in response to the activation request when a physical quantity representing a power consumption of the predetermined in-vehicle device is equal to or more than a predetermined threshold value while charging of the battery is stopped and the power supply connector is connected to the inlet.

2. The electrified vehicle according to claim 1, wherein the physical quantity is a count of activation of the predetermined in-vehicle device while the charging of the battery is stopped and the power supply connector is connected to the inlet.

3. The electrified vehicle according to claim 1, wherein the physical quantity is an operation period of the predetermined in-vehicle device while the charging of the battery is stopped and the power supply connector is connected to the inlet.

4. The electrified vehicle according to claim 1, wherein the physical quantity is an amount of discharged power of the auxiliary battery while the charging of the battery is stopped and the power supply connector is connected to the inlet.

5. The electrified vehicle according to claim 1, wherein the control device is configured to, when the power supply connector is detached from the inlet, terminate prohibition of activation of the predetermined in-vehicle device in response to the activation request and reset the physical quantity to zero.
